(19) United States
(12) Patent Application Publication
(10) Pub. No.: US 2007/0288957 A1
(43) Pub. Date: Dec. 13, 2007

(54) Method and system for controlling an electronic program guide

(75) Inventor: Yi-Hsiu Lee, Taipei City (TW)

Correspondence Address: BACON & THOMAS, PLLC, 625 SLATERS LANE, FOURTH FLOOR, ALEXANDRIA, VA, 22314, US

(73) Assignee: ASUSTEK COMPUTER INC., Taipei City (TW)

(21) Appl. No.: 11/717,118

(22) Filed: Mar. 13, 2007

(30) Foreign Application Priority Data
Mar. 29, 2006 (TW) 095111037

(51) Int. Cl. H04N 5/445

(52) U.S. Cl. 725/39

(57) ABSTRACT

A system and method for controlling an electronic program guide utilizes a remote control device and a television to realize the program field selection of the electronic program table, wherein the electronic program table includes a plurality of time-interval program tables, each having a plurality of the program fields. The remote control device includes a first directional control key set for generating a first controlling signal, and a second directional control key set for generating a second controlling signal. When the television receives the first controlling signal, the television switches the time-interval program table displayed by the television to another interval program table. When the television receives the second controlling signal, the television switches the displayed program field to another program field.

### BACKGROUND OF THE INVENTION

1. Field of the Invention

The present invention relates to a digital television, and more particularly, to a method and a system for controlling an electronic program guide.

2. Description of Related Art

The electronic program guides are program guides displayed by the televisions or similar electronic devices. FIG. 1 is a schematic drawing of a conventional electronic program guide. The conventional electronic program guide 1 has a plurality of channel items 111, 112, 113, a plurality of channel names 121, 122, 123, a date item 13, a plurality of time sections 141, 142, 143, 144 and a plurality of program items 151, 152, 153, 154.

For example, the channel item 111 is the 27-th channel, and its channel name 121 is DISCOVERY channel; the date item 13 is February 10, and the plurality of program items 151, 152, 153, 154 are: “Elephant's Empire: The Long Childhood” at 8:00, “Mythbusters: Series 3: Jet Pack/pyramid Power” at 9:00, “Mystery Of The Disorderly Warriors” at 10:00, and “Hour Asia: Shanghai Opera Dream s” at 23:00.

Usually, the user can select demanded program information from the electronic program guide 1 or record a program by the television or the related apparatus via selecting the program item of the electronic program guide 1. In conventional skill, users can use the arrow keys on the remote control device; for example, the user can press the right arrow key once to move to the next right selection; and the user can press the left arrow key once to move to next left selection. However, this method is not very convenient.

For example, if the electronic program guide 1 displayed on the television has a selected program item 153, and the user wants to set up to record the “Hour Asia: Shanghai Opera Dream s” at 23:00 on February 10, he or she needs to press the right arrow key several times to move from one program item to another. Furthermore, since the electronic program guide 1 uses one hour as a time section unit, in this example, the program item 153 (Mystery Of The Disorderly Warriors) at 10:00 is selected. If the user wants to move the selection to the program item 153 (Hour Asia: Shanghai Opera Dream) at 23:00, he or she needs to press the right arrow key 14 times. Therefore, such a process to control the electronic program guide is inefficient, and it is desirable to provide a method and a system for controlling an electronic program guide to mitigate and/or obviate the aforementioned problems.

### SUMMARY OF THE INVENTION

The present invention provides a method and a system for controlling an electronic program guide, which can simplify the control operation.

According to an aspect of the present invention, a method for controlling an electronic program guide is provided. The electronic program guide includes a plurality of time-interval program tables, each having a plurality of the program fields. The steps of the method include: receiving a first control signal or a second control signal; when the first control signal is received, switching to a time-interval program table that is selected from the plurality of the time-interval program tables, and displaying the selected time-interval program table in a selected status; and when the second control signal is received, switching to a program field that is selected from the plurality of program fields in the selected time-interval program table being displayed in the selected status, and displaying the selected the program field in a selected status.

According to another aspect of the present invention, a system for controlling an electronic program guide is provided. The system includes a control device and a television. The control device includes a first directional control key set and a second directional control key set. When the first directional control key set is pressed, a first control signal is generated, and when the second directional control key is pressed, a second control signal is generated. The television displays an electronic program guide, which includes a plurality of time-interval program tables. Each time-interval program table has a plurality of the program fields. When the first control signal is received, the television switches to a time-interval program table that is selected form the plurality of the time-interval program tables, and displays the time-interval program table in a selected status. When the second control signal is received, the television switches to a program field that is selected from the plurality of program fields in the selected time-interval program table, and displays the selected program field in a selected status.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a prior art electronic program guide;

FIG. 2 is a system schematic drawing of a preferred embodiment of the present invention;

FIG. 3 is a flow chart of the preferred embodiment of the present invention;

FIG. 4a is a schematic drawing of an electronic program guide in the preferred embodiment of the present invention;

FIG. 4b is another schematic drawing of an electronic program guide in the preferred embodiment of the present invention;

FIG. 4c is a further schematic drawing of an electronic program guide in the preferred embodiment of the present invention; and

FIG. 5 is a system schematic drawing of another preferred embodiment of the present invention.

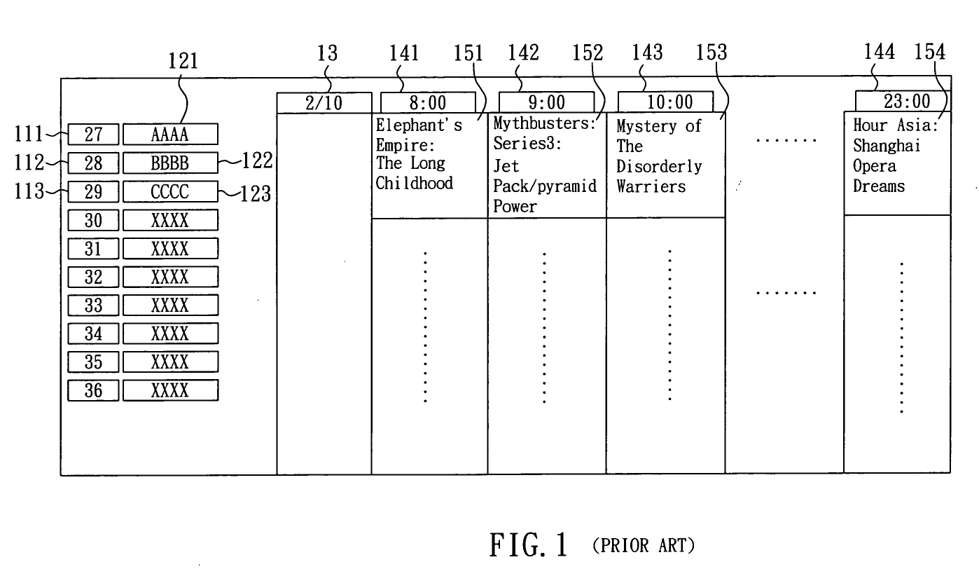

### DETAILED DESCRIPTION OF THE PREFERRED EMBODIMENT

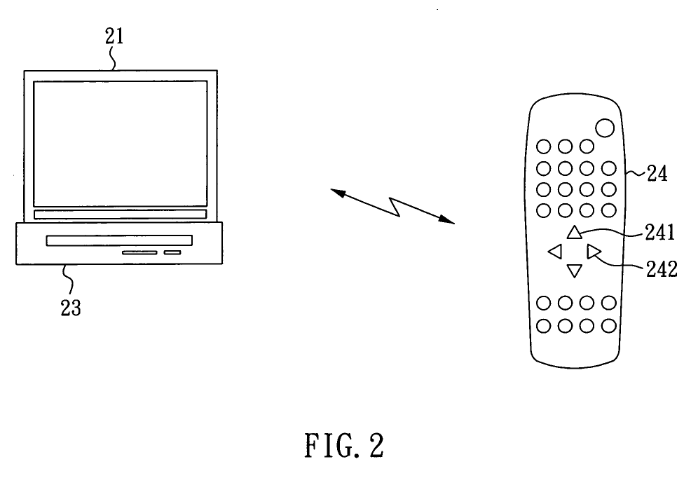

Please refer to FIG. 2. FIG. 2 is a system schematic drawing of a preferred embodiment of the present invention. The control system of an electronic program guide of the present invention comprises a television 21, an attached device 23 and a remote control device 24. The remote control device 24 comprises a first directional control key set 241 and a second directional control key set 242.

In this embodiment, the first directional control key set 241 comprises an up key and a down key, and the second directional control key set 242 comprises a left key and a right key. In another embodiment, the first directional control key set 241 comprises a left key and a right key, and the second directional control key set 242 comprises an up key and a down key. Of course, in other embodiments, the first directional control key set 241 and the second directional control key set 242 can be other suitable keys.

In this embodiment, the television 21 can be a traditional television or a digital television, the attached device 23 can a video recorder, and the remote control device 24 can be a typical remote control.

The television 21 works with the remote control device 24, and the user can use the remote control device 24 to select the program fields contained in the electronic program guide.

When the first directional control key set 241 is pressed, a first control signal is generated; when the second directional control key set 242 is pressed, a second control signal is generated. In this embodiment, the television 21 receives the first control signal or the second control signal generated by the remote control device 24 and generates a first menu control signal or a second menu control signal according to the first control signal or the second control signal, so as to select the program field in the electronic program guide to be displayed.

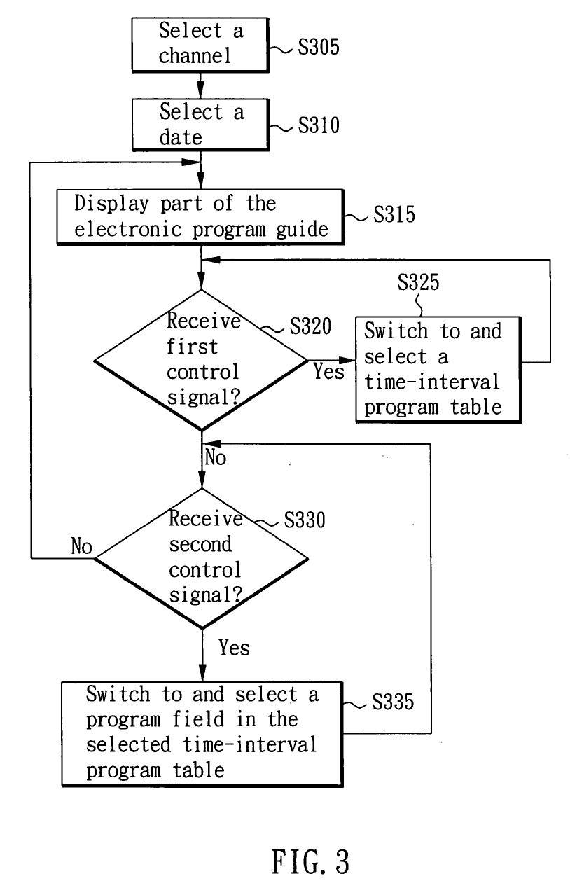

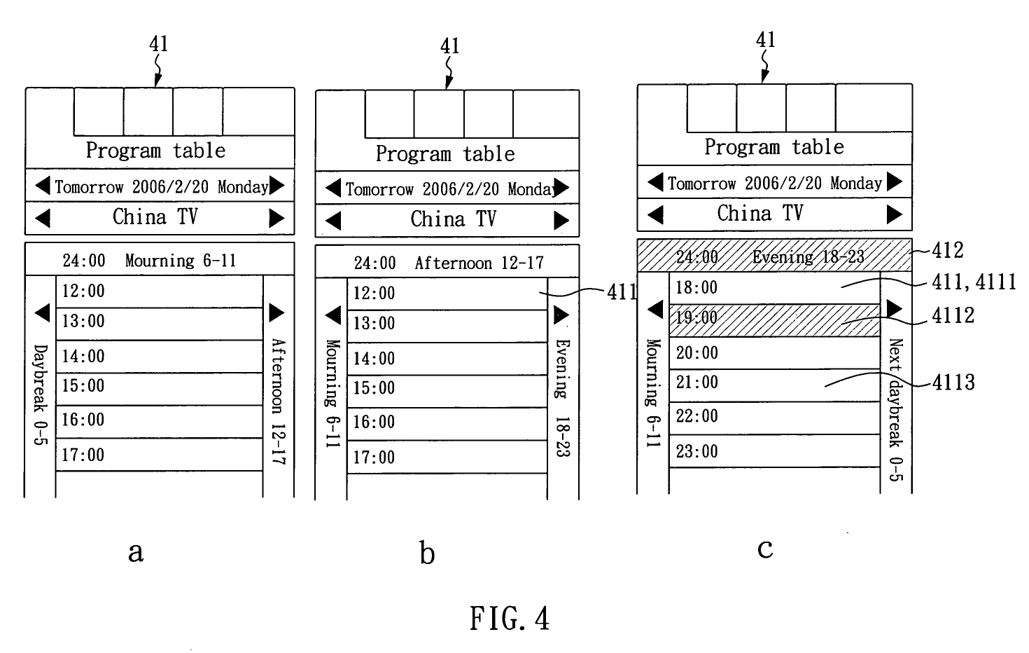

For further description of this embodiment, please refer to FIG. 2, FIG. 3, and FIG. 4. FIG. 3 is a flow chart of the preferred embodiment of the present invention. FIG. 4 shows a schematic drawing of an electronic program guide in the preferred embodiment of the present invention. As shown in FIG. 4, the electronic program guide comprises a plurality of time-interval program tables 41 and each time-interval program table 41 further comprises a plurality of program fields 411.

In this embodiment, if the user wants to program to record the program that is at 21:00 on Feb. 20, 2006, he or she can operate the following steps. First, after the user turns on the television 21, he or she can use the remote control device 24 to select the channel or date (steps S305 and S310), and the television 21 displays certain part of the electronic program guide, i.e., the television 21 only displays one time-interval program table 41 form the electronic program guide (step S315). Although, in this embodiment, step S305 is performed before step S310 and S315, this operation sequence may be altered based on the actual requirement.

Next, the television 21 determines whether it receives the first control signal generated by pressing the first directional control key set 241 of the remote control device 24 (step S320). If the user press the first directional control key set 241 of the remote control device 24 (for example: the left key or the right key), the television 21 receives the first control signal, and the television 21 switches the currently selected time-interval program table 41 (as shown in FIG. 4b) to the next time-interval program table 41 (as shown in FIG. 4c) or the previous time-interval program table 41 (as shown in FIG. 4a) according to the first control signal (step S325). Furthermore, the television 21 displays the newly selected time-interval program table 41 in a “selected” status (for example, highlighting program fields 412 of the time-interval program table 41), as shown in FIG. 4c.

Moreover, the first control signal can be the signal generated by pressing the left key and the signal generated by pressing the right key, wherein the signal generated by pressing the left key and the signal generated by pressing the right key might have the same wave shape but opposite phases. Furthermore, the second control signal can be the signal generated by pressing the up key and the signal generated by pressing the down key, wherein the signal generated by pressing the up key and the signal generated by pressing the down key might have the same wave shape but opposite phases. Therefore, the television 21 can check the received signal and switch the time-interval program table 41 in the electronic program guide according to the received signal.

If the television 21 does not receive the first control signal, the television 21 checks whether it receives the second control signal (step S330). If the television 21 does not receive the second control signal, the television 21 displays the original electronic program guide (step S315).

If the television 21 receives the second control signal, the television 21 switches the current program field 4111 in the time-interval program table 41 to another selected program field 4112, and the television 21 displays this selected program field 4112 in a “selected” status (such as be highlighted) (step S335). Furthermore, in other embodiment, step S320 and step S330 can be performed in opposite sequence.

Therefore, when the user wants to select the program field scheduled at 21:00 on February 20, and the television 21 currently displays the time-interval program table 41 for the afternoon (as shown in FIG. 4b) of the electronic program guide, the user only needs to press once the right key of the first directional control key set 241, and the television 21 switches to the time-interval program table 41 for the evening (as shown in FIG. 4c). Then, the user only needs to press the down key of the first directional control key set 242 three times to switch to the selected program field 4113. Therefore, the user can switch to the selected program field easily.

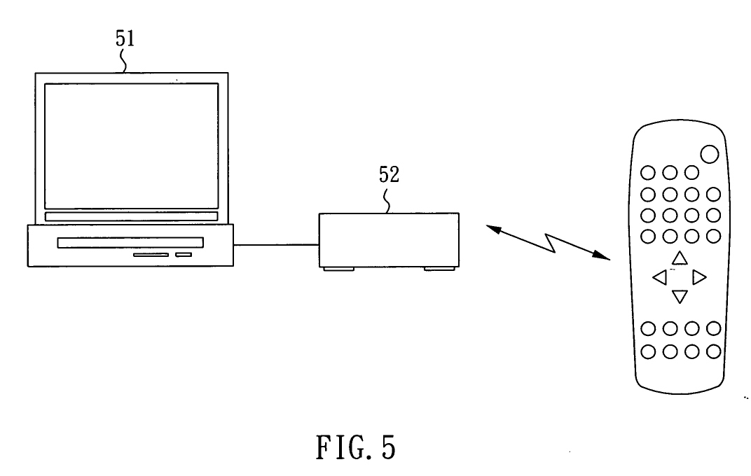

Please refer to FIG. 5. FIG. 5 is a system schematic drawing of another preferred embodiment of the present invention. The second embodiment is similar to the first embodiment except that a television 51 is electrically connected to a set-top box 52. Furthermore, the operation process of this embodiment is also similar to the previous embodiment, but the television 51 utilizes the set-top box 52 to receive the first control signal and the second control signal, and the set-top box 52 generates control signals to control the television 51 to switch the time-interval program table or the program field.

Consequently, the present invention can utilize the first directional control key set and the second directional control key set to select the program field. The first control signal generated by pressing the first directional control key set can switch the television from one time-interval program table to another time-interval program table; and the second directional control key set generated by pressing the second control signal can switch the television from one program field to another program field. Therefore, the user is able to rapidly select the desired program field.

Although the present invention has been explained in relation to its preferred embodiment, it is to be understood that many other possible modifications and variations can be made without departing from the spirit and scope of the invention as hereinafter claimed.

What is claimed is:

1. A method for controlling an electronic program guide, the electronic program guide including a plurality of time-interval program tables, each having a plurality of the program fields, the method comprising:
receiving a first control signal or a second control signal;
when the first control signal is received, switching to a time-interval program table that is selected from the plurality of the time-interval program tables, and displaying the selected time-interval program table in a selected status; and
when the second control signal is received, switching to a program field that is selected from the plurality of program fields in the selected time-interval program table, and displaying the selected the program field in a selected status.

2. The method as claimed in claim 1, wherein the first control signal is generated by pressing left or right key of a control device, and the second control signal is generated by pressing up or down key of the control device.

3. The method as claimed in claim 1, wherein the first control signal is generated by pressing up or down key of a control device, and the second control signal is generated by pressing left or right key of the control device.

4. The method as claimed in claim 1 further comprising:
receiving the first control signal and the second control signal from a set-top box; and
transmitting the first control signal and the second control signal from the set-top box to a television, the television displaying the selected time-interval program table and the selected program field.

5. A system for controlling an electronic program guide comprising:
a control device including a first directional control key set and a second directional control key set, wherein, when the first directional control key set is pressed, a first control signal is generated, and when the second directional control key is pressed, a second control signal is generated; and
a television displaying an electronic program guide, which including a plurality of time-interval program tables, each time-interval program table having a plurality of the program fields;
wherein when the first control signal is received, the television switches to a time-interval program table that is selected form the plurality of the time-interval program tables, and displays the time-interval program table in a selected status; when the second control signal is received, the television switches to a program field that is selected from the plurality of program fields in the selected time-interval program table, and displays the selected program field in a selected status.

6. The system as claimed in claim 5, wherein the television is electrically connected to a set-top box, and the television receives the first control signal and the second control signal from the set-top box.

7. The system as claimed in claim 5, wherein the control device is a TV remote control.

8. The system as claimed in claim 7, wherein the first directional control key set includes a left key and a right key of the TV remote control, and the second directional control key set includes a up key and a down key of the TV remote control.

9. The system as claimed in claim 7, wherein the first directional control key set includes a up key and a down key of the TV remote control, and the second directional control key set includes a left key and a right key of the TV remote control.
